(19) United States
(12) Patent Application Publication
(10) Pub. No.: US 2022/0172153 A1
(43) Pub. Date: Jun. 2, 2022

(54) TRANSPORTATION MANAGEMENT DEVICE, TRANSPORTATION MANAGEMENT SYSTEM, TRANSPORTATION MANAGEMENT METHOD, AND RECORDING MEDIUM

(71) Applicant: TOYOTA JIDOSHA KABUSHIKI KAISHA, Toyota-shi Aichi-ken (JP)

(72) Inventors: Takaaki Yanagihashi, Toyota-shi Aichi-ken (JP); Takahiro Okano, Chiryu-shi Aichi-ken (JP); Toru Takashima, Susono-shi Shizuoka-ken (JP); Hiroaki Kiyokami, Nisshin-shi Aichi-ken (JP); Kenta Miyahara, Okazaki-shi Aichi-ken (JP); Yohei Tanigawa, Toyota-shi Aichi-ken (JP)

(73) Assignee: TOYOTA JIDOSHA KABUSHIKI KAISHA, Toyota-shi Aichi-ken (JP)

(21) Appl. No.: 17/493,250

(22) Filed: Oct. 4, 2021

(30) Foreign Application Priority Data
Nov. 30, 2020 (JP) 2020-198436

(51) Int. Cl. G06Q 10/08

(52) U.S. Cl. CPC G06Q 10/083

(57) ABSTRACT

A center server including a CPU is provided. The CPU instructs a vehicle to transport a product from a manufacturer of the product to a transportation destination, and instructs, after the vehicle has transported the product, the vehicle to transport an article related to the product from the transportation destination to the manufacturer, based on a demand for the article.

### CROSS-REFERENCE TO RELATED APPLICATION

This application claims priority to Japanese Patent Application No. 2020-198436 filed on Nov. 30, 2020, incorporated herein by reference in its entirety.

### BACKGROUND

### 1. Technical Field

The present disclosure relates to a transportation management device, a transportation management system, a transportation management method, and a recording medium.

### 2. Description of Related Art

A technique related to a transportation system for transporting articles from a place of shipment to a destination using a loading container has been proposed. Japanese Unexamined Patent Application Publication No. 2003-300621 (JP 2003-300621 A) discloses a technique of a management method in which resin tubes are stored in a rack or a container and transported from the place of shipment to the destination and a recycled material of the resin tubes is stored in the rack or the container to be collected on the return route from the destination.

### SUMMARY

Although there is a technique related to a transportation system for transporting articles from the place of shipment to the destination as described above, there is still room for improvement in terms of efficient transportation using vehicles that have transported manufactured products.

The present disclosure has been made in view of the above points, and it is an object of the present disclosure to provide a transportation management device, a transportation management system, a transportation management method, and a recording medium that improve efficiency of transportation by using vehicles that have transported products.

A transportation management device according to a first aspect includes a processor. The processor instructs a vehicle to transport a product from a manufacturer of the product to a transportation destination, and instructs, after the vehicle has transported the product, the vehicle to transport an article related to the product from the transportation destination to the manufacturer, based on a demand for the article.

The transportation management device according to the first aspect instructs a vehicle to transport a product from a manufacturer of the product to a transportation destination, and instructs, after the vehicle has transported the product, the vehicle to transport an article related to the product from the transportation destination to the manufacturer, based on a demand for the article. With the transportation management device according to the first aspect, the vehicle that has transported a part is used for transporting another part, so that the efficiency of transportation can be improved.

According to a transportation management device according to a second aspect, in the transportation management device according to the first aspect, the article is a material used for manufacturing the product.

In the transportation management device according to the second aspect, the processor instructs the vehicle to transport the material used for manufacturing the product, as the article. With the transportation management device according to the second aspect, the vehicle is instructed to transport the material used for manufacturing the product, so that the efficiency of transportation of the material can be improved.

According to a transportation management device according to a third aspect, in the transportation management device according to the second aspect, the transportation destination is located between a supplier of the material and the manufacturer, and is a facility that temporarily stores the material and a facility that temporarily stores the product.

In the transportation management device according to the third aspect, the transportation destination is located between a supplier of the material and the manufacturer, and is a facility that temporarily stores the material and a facility that temporarily stores the product. With the transportation management device according to the third aspect, the product is transported to the facility that temporarily stores the material, so that the vehicle used for transportation can be operated efficiently.

According to a transportation management device according to a fourth aspect, in the transportation management device according to any one of the first to third aspects, the processor manages inventory of the article at the manufacturer based on demand information of the product.

In the transportation management device according to the fourth aspect, the processor manages inventory of the article at the manufacturer based on demand information of the product. With the transportation management device according to the fourth aspect, the inventory of the article is managed based on the demand information of the products and an instruction is made to transport the article from the transportation destination when the demand for the product increases, so that the efficiency of transportation can be improved.

According to a transportation management device according to a fifth aspect, in the transportation management device according to the fourth aspect, the processor manages the inventory of the article based on the demand information obtained based on malfunction information of another vehicle.

In the transportation management device according to the fifth aspect, the processor manages the inventory of the article based on the demand information obtained based on acquired malfunction information of another vehicle. With the transportation management device according to the fifth aspect, an instruction is made to transport the article from the transportation destination to secure the article used for the product, for which demand is expected to increase, based on the demand information obtained based on the malfunction information of another vehicle, so that the efficiency of transportation can be improved.

According to a transportation management device according to a sixth aspect, in the transportation management device according to the fourth aspect, the processor manages the inventory of the article based on the demand information obtained based on weather information.

In the transportation management device according to the sixth aspect, the processor manages the inventory of the article based on the demand information obtained based on weather information. With the transportation management device according to the sixth aspect, an instruction is made to transport the article from the transportation destination to secure the article used for the product, for which demand is expected to increase, based on the demand information obtained based on the weather information, so that the efficiency of transportation can be improved.

According to a transportation management device according to a seventh aspect, in the transportation management device according to any one of the first to third aspects, the processor manages inventory of the article related to the product at the manufacturer based on demand forecast for the product.

In the transportation management device according to the seventh aspect, the processor manages inventory of the article related to the product at the manufacturer based on demand forecast for the article itself used for the product. With the transportation management device according to the seventh aspect, an instruction is made to transport the article, for which demand is expected to increase, from the transportation destination to secure the article, so that the efficiency of transportation can be improved.

According to a transportation management device according to an eighth aspect, in the transportation management device according to the first aspect, when there is no article to transport, the processor makes an instruction that transportation of the article is unnecessary to the vehicle.

In the transportation management device according to the eighth aspect, when there is no article to transport, the processor makes an instruction that transportation of the article is unnecessary to the vehicle. With the transportation management device according to the eighth aspect, when there is no article to transport, an instruction is made that transportation of the article is unnecessary to the vehicle, so that another delivery plan after transportation by the vehicle can be prepared.

A transportation management system according to the ninth aspect includes: the transportation management device according to any one of the first to eighth aspects; and one or more vehicles that receive an instruction from the transportation management device. In the transportation management system according to the ninth aspect, as the number of vehicles connected to the transportation management device increases, the efficiency of transportation of both the product and the article can be improved.

A transportation management method according to a tenth aspect is performed through execution of processes by a processor. The processes includes: instructing a vehicle to transport a product from a manufacturer of the product to a transportation destination; and instructing, after the vehicle has transported the product, the vehicle to transport an article related to the product from the transportation destination to the manufacturer, based on a demand for the article.

In the transportation management method according to the tenth aspect, the processor instructs a vehicle to transport a product from a manufacturer of the product to a transportation destination, and instructs, after the vehicle has transported the product, the vehicle to transport an article related to the product from the transportation destination to the manufacturer, based on a demand for the article. With the transportation management method according to the tenth aspect, the vehicle that has transported a part is used for transporting another part, so that the efficiency of transportation can be improved.

A recording medium according to an eleventh aspect stores a transportation management program that causes a computer to execute processes including: instructing a vehicle to transport a product from a manufacturer of the product to a transportation destination; and instructing, after the vehicle has transported the product, the vehicle to transport an article related to the product from the transportation destination to the manufacturer, based on a demand for the article.

The recording medium according to the eleventh aspect causes a computer to instruct a vehicle to transport a product from a manufacturer of the product to a transportation destination, and instruct, after the vehicle has transported the product, the vehicle to transport an article related to the product from the transportation destination to the manufacturer, based on a demand for the article. With the recording medium according to the eleventh aspect, the vehicle that has transported a part is used for transporting another part, so that the efficiency of transportation can be improved.

According to the present disclosure, it is possible to provide a transportation management device, a transportation management system, a transportation management method, and a recording medium that improve efficiency of transportation using a vehicle that has transported a product.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing a schematic configuration of a transportation management system according to the present embodiment;

FIG. 2 is a diagram showing an example of a hardware configuration of a vehicle;

FIG. 3 is a diagram showing an example of a hardware configuration of a center server;

FIG. 4 is a diagram showing an example of a functional configuration of the center server;

FIG. 5 is a flowchart showing an example of a transportation management method performed by the center server;

FIG. 6 illustrates the transportation management method performed by the center server; and

FIG. 7 is a diagram showing an example of information regarding a transportation instruction generated by the center server.

### DETAILED DESCRIPTION OF EMBODIMENTS

Hereinafter, an example of an embodiment of the present disclosure will be described with reference to the drawings. The same reference signs are assigned to the same or equivalent components and parts in the drawings. In addition, the dimensional ratios in the drawings are exaggerated for convenience of description and may differ from the actual ratios.

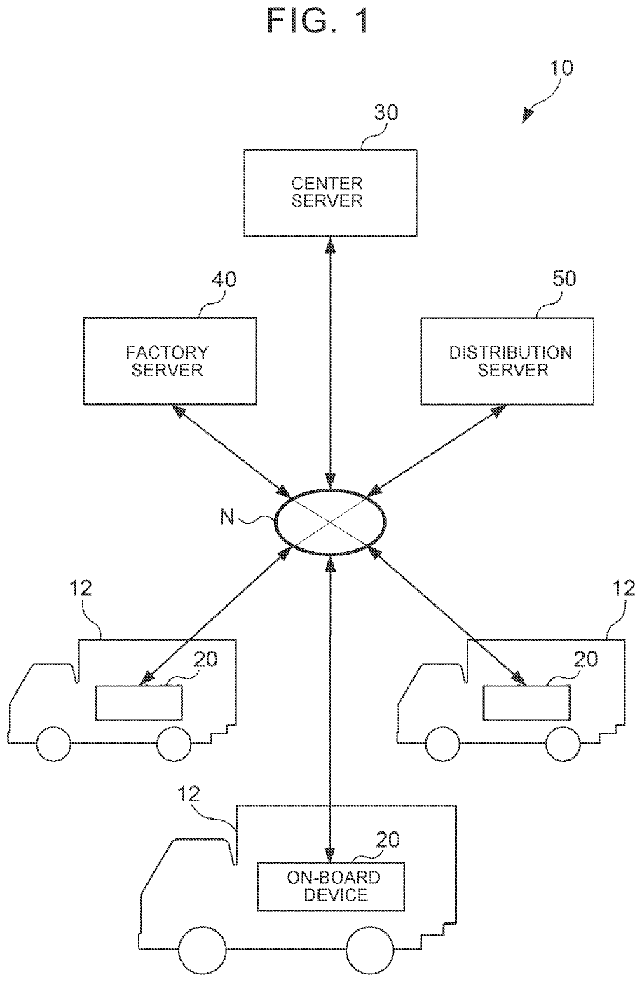

FIG. 1 is a diagram showing a schematic configuration of a transportation management system according to the present embodiment. As shown in FIG. 1, a transportation management system 10 according to the present embodiment includes a plurality of vehicles 12, a center server 30, a factory server 40, and a distribution server 50. Although three vehicles 12 are shown in FIG. 1, the number of vehicles 12 is not limited to this example.

The vehicles 12 are vehicles used for transporting products manufactured in a factory and articles used for the products, and are, for example, trucks. Each vehicle 12 includes an on-board device 20. The vehicles 12 according to the present embodiment transport, as the articles, materials used for manufacturing the products, for example.

The on-board devices 20 of the vehicles 12, the center server 30, the factory server 40, and the distribution server 50 are connected to each other via a network N.

The center server 30 is an example of a transportation management device. The center server 30 is a server that generates instructions for the vehicles 12 and notifies the vehicles 12 of the instructions. The factory server 40 is a server that manages a factory that manufactures products or articles used for the products. The distribution server 50 is a server that manages the distribution of products manufactured in the factory and articles used for the products.

### Vehicle

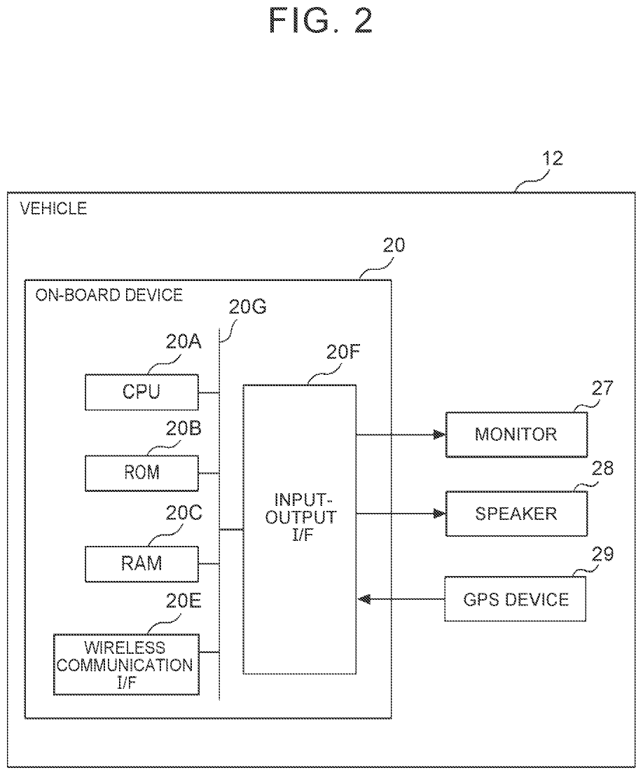

FIG. 2 is a diagram showing an example of a hardware configuration of the vehicle. As shown in FIG. 2, the vehicle 12 according to the present embodiment includes the on-board device 20. The vehicle 12 further includes a monitor 27, a speaker 28, and a Global Positioning System (GPS) device 29.

The on-board device 20 includes a central processing unit (CPU) 20A, a read-only memory (ROM) 20B, a random access memory (RAM) 20C, a wireless communication interface (I/F) 20E, and an input-output I/F 20F. The CPU 20A, the ROM 20B, the RAM 20C, the wireless communication I/F 20E and the input-output I/F 20F are connected so as to be able to communicate with each other via an internal bus 20G.

The CPU 20A is a central processing unit that executes various programs and controls various units. That is, the CPU 20A reads the program from the ROM 20B and executes the program using the RAM 20C as a work area.

The ROM 20B stores various programs and various data. The ROM 20B of the present embodiment stores a control program for controlling the on-board device 20.

The RAM 20C temporarily stores a program or data as a work area.

The wireless communication I/F 20E is a wireless communication module for communicating with the center server 30, the factory server 40, and the distribution server 50. For the wireless communication module, for example, communication standards such as 5th Generation Mobile Communication System (5G), Long Term Evolution (LTE), and Wi-Fi (registered trademark) are used. The wireless communication I/F 20E is connected to the network N.

The input-output I/F 20F is an interface for communicating with the monitor 27, the speaker 28, and the GPS device 29 mounted on the vehicle 12.

The monitor 27 is a liquid crystal monitor provided on an instrument panel, a meter panel, or the like for displaying an image related to the current position, a traveling route, and caution information. The monitor 27 may be provided with a touch panel that also serves as a switch for inputting an operation by the occupant's fingers.

The speaker 28 is a device provided in an instrument panel, a center console, a front pillar, a dashboard, or the like for outputting a sound.

The GPS device 29 is a device that measures the current position of the vehicle 12. The GPS device 29 includes an antenna (not shown) that receives signals from GPS satellites.

### Center Server

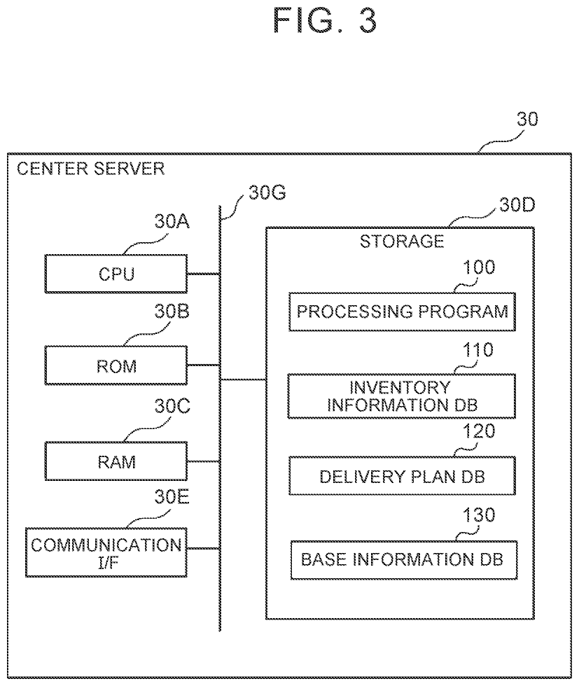

FIG. 3 is a diagram showing an example of a hardware configuration of the center server. As shown in FIG. 3, the center server 30 includes a CPU 30A, a ROM 30B, a RAM 30C, a storage 30D, and a communication I/F 30E. The CPU 30A, the ROM 30B, the RAM 30C, the storage 30D, and the communication I/F 30E are connected so as to be able to communicate with each other via an internal bus 30G. The functions of the CPU 30A, the ROM 30B, the RAM 30C and the communication I/F 30E are the same as those of the CPU 20A, the ROM 20B, the RAM 20C and the wireless communication I/F 20E of the on-board device 20 described above.

The storage 30D is composed of a hard disk drive (HDD) or a solid state drive (SSD), and stores various programs and various data.

The CPU 30A reads the program from the storage 30D and executes the program using the RAM 30C as a work area.

A processing program 100, an inventory information database (DB) 110, a delivery plan DB 120, and a base information DB 130 are recorded in the storage 30D of the present embodiment.

The processing program 100 is an example of a transportation management program, and is a program for realizing each function of the center server 30.

The inventory information DB 110 is a database that stores inventory information of products. The inventory information DB 110 stores information on the amount of inventory for each product as the inventory information.

The delivery plan DB 120 is a database that stores the delivery plan of the product for the vehicle 12. The delivery plan DB 120 stores, for example, information on a vehicle for transporting the product, a date and time of transportation, a product to be transported, a manufacturer of the product, and a transportation destination of the product, as a delivery plan.

The base information DB 130 is a database that stores information on the base related to transportation of the product. The base information DB 130 stores, for example, information for identifying the base, information on the type of the base, and information on the location of the base as the information on the base.

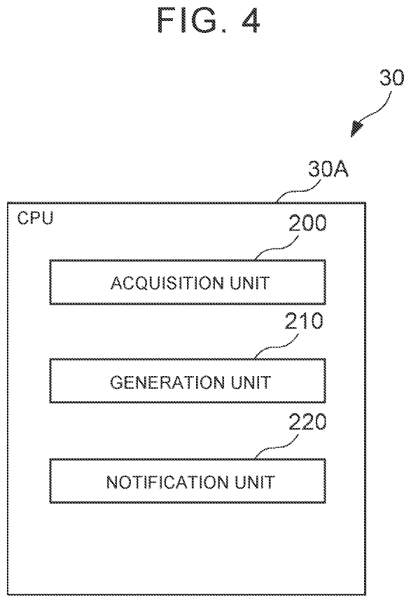

FIG. 4 is a diagram showing an example of a functional configuration of the center server. In the center server 30 of the present embodiment, the CPU 30A executes the processing program 100 to function as an acquisition unit 200, a generation unit 210, and a notification unit 220 shown in FIG. 4.

The acquisition unit 200 acquires the information recorded in the inventory information DB 110, the delivery plan DB 120, and the base information DB 130.

The generation unit 210 uses the information acquired by the acquisition unit 200 to generate information to be notified to the vehicle 12. Specifically, the generation unit 210 generates information for causing the vehicle 12 to transport the product from the manufacturer of the product to the transportation destination. Also, the generation unit 210 generates information for instructing the vehicle 12 that has transported the product to the transportation destination to transport the article related to the product from the transportation destination to the manufacturer based on a demand for the article. The transportation destination to which the product is transported is located between the manufacturer that manufactures the product and the supplier of the material used for manufacturing the product. The transportation destination is a facility that temporarily stores the product transported from the manufacturer and a facility that temporarily stores the material transported from the supplier of the material.

Further, the generation unit 210 generates a delivery plan for the vehicle 12 to transport the article related to the product from the transportation destination to the manufacturer. For example, the generation unit 210 manages the inventory of the article of the manufacturer based on the demand information of the product, and generates a delivery plan of the article from the transportation destination to the manufacturer, as needed. The vehicle 12 uses a common transportation body such as a container or a pallet when transporting a part from the manufacturer of the product to the transportation destination and when transporting the article from the transportation destination to the manufacturer.

For example, the generation unit 210 may manage the inventory of the article of the manufacturer based on the demand information obtained based on vehicle malfunction information, and may generate the delivery plan of the article from the transportation destination to the manufacturer, as needed. The vehicle malfunction information may be acquired by the acquisition unit 200 from each vehicle, for example, through the execution of a self-diagnosis function of each vehicle. When the demand for a specific product is expected to increase based on the vehicle malfunction information, the generation unit 210 may generate a delivery plan for transporting the material used for the product to the manufacturer.

For example, the generation unit 210 may manage the inventory of the article of the manufacturer based on the demand information obtained based on weather information, and may generate a delivery plan of the article from the transportation destination to the manufacturer, as needed. For example, when it is found that it will snow in a few days ahead as a result of referring to the weather information, the generation unit 210 may generate a delivery plan of products that are often used during snowfall such as tire chains or studless winter tires.

For example, the generation unit 210 may manage the inventory of the article of the manufacturer based on the demand forecast for the article itself used for the product, and may generate a delivery plan of the article from the transportation destination to the manufacturer, as needed. By managing the inventory of the article based on the demand forecast for the article itself used for the product, the center server 30 can make an instruction to transport the article, for which demand is expected to increase, from the transportation destination to secure the article. The center server 30 can improve the efficiency of transportation by the vehicles 12 by making an instruction to transport the article, for which demand is expected to increase, from the transportation destination to secure the article.

The notification unit 220 notifies the on-board device 20 of the target vehicle 12 of the information generated by the generation unit 210 through the network N. When the on-board device 20 receives the notification, the CPU 20A of the on-board device 20 displays on the monitor 27 the information based on the received notification.

### Flow of Control

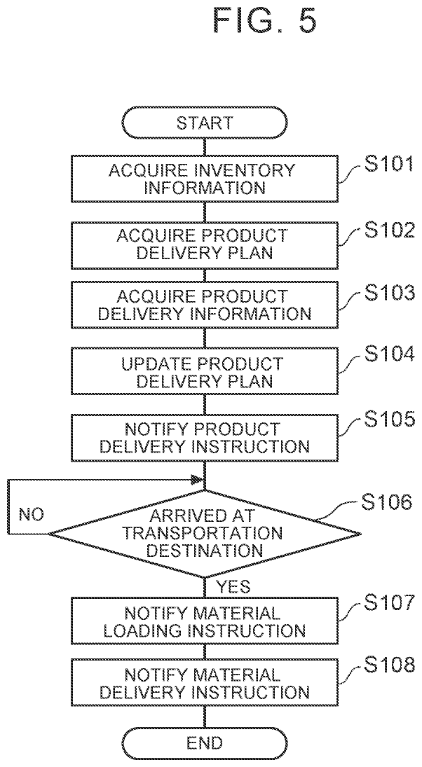

Next, the flow of control by the center server 30 will be described. FIG. 5 is a flowchart showing an example of the flow of the transportation management method performed by the center server 30. The transportation management method shown in FIG. 5 is performed by the CPU 30A through execution of the processing program 100.

The CPU 30A acquires the inventory information of the product from the inventory information DB 110 (step S101).

Following step S101, the CPU 30A acquires information on the delivery plan of the product for which the inventory information was acquired in step S101, from the delivery plan DB 120 (step S102).

Following step S102, the CPU 30A acquires the delivery information of the product for which the inventory information was acquired in step S101 (step S103). The delivery information of the product is, for example, information indicating which product was delivered, and when, from where, to where, and how much the product was delivered.

Following step S103, the CPU 30A updates the information on the delivery plan of the product using the acquired delivery information of the product (step S104).

Following step S104, the CPU 30A notifies the vehicle 12 that transports the product of a product transportation instruction based on the information on the delivery plan of the product updated in step S104 (step S105). Upon receiving the notification from the center server 30, the driver of the vehicle 12 loads the product on the vehicle 12 based on the notification and the product is transported from the manufacturer (for example, the factory of the product) to the transportation destination (for example, the distribution center where the product is temporarily stored).

Following step S105, the CPU 30A determines whether the vehicle 12 has arrived at the transportation destination of the product (step S106). The CPU 30A may determine whether the vehicle 12 has arrived at the transportation destination of the product, based on the position information acquired by the GPS device 29 of the vehicle 12, for example.

When the CPU 30A determines that the vehicle 12 has not arrived at the transportation destination of the product (step S106; No), the CPU 30A repeats the process of step S106 until the vehicle 12 arrives at the transportation destination of the product.

When the CPU 30A determines that the vehicle 12 has arrived at the transportation destination of the product (step S106; Yes), the CPU 30A instructs the vehicle 12 that has finished transporting the product to load the material at the transportation destination based on the demand for the material (step S107). The material for which instruction of loading is made in step S107 is a material used for manufacturing the product at the manufacturer of the product.

Following step S107, the CPU 30A instructs the vehicle 12 on which the material is loaded to transport the material to the manufacturer (step S108).

The center server 30 executes a series of processes shown in FIG. 5, so as to be able to output a notification for causing the vehicle 12 that has transported the product from the manufacturer of the product to the transportation destination to transport the article when returning to the manufacturer, based on the demand for the article related to the product. The center server 30 outputs the notification for causing the vehicle 12 to transport the article related to the product when returning to the manufacturer of the product, so that the center server 30 can improve the efficiency of transportation by the vehicle 12 compared with a case where the vehicle 12 does not transport the article related to the product.

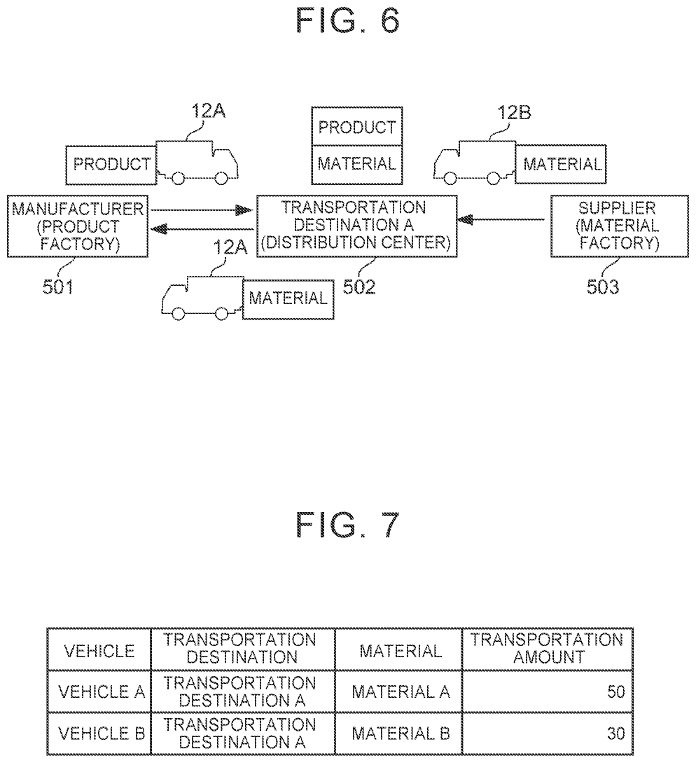

The transportation management method performed by the center server 30 will be described with reference to FIG. 6. A vehicle 12A is a vehicle instructed by the center server 30 to transport the product from a manufacturer 501 to a transportation destination 502. The manufacturer 501 is, for example, a product factory, and the transportation destination 502 is a distribution center that temporarily stores products supplied by the manufacturer 501 and materials supplied by a supplier 503. The supplier 503 transports the material used for the product manufactured by the manufacturer 501 to the transportation destination 502 by the vehicle 12B.

The vehicle 12A that has transported the product from the manufacturer 501 to the transportation destination 502 based on the instruction from the center server 30 receives an instruction from the center server 30 to load the material at the transportation destination 502 and move to the manufacturer 501. The vehicle 12A transports the material loaded at the transportation destination 502 to the manufacturer 501 based on the instruction from the center server 30.

FIG. 7 is a diagram showing an example of information regarding a transportation instruction generated by the CPU 30A of the center server 30 in the example shown in FIG. 6. The CPU 30A generates an instruction for transporting 50 pieces of material A from the transportation destination 502 (transportation destination A) and notifies a vehicle 12 (vehicle A) of the instruction. The CPU 30A generates an instruction for transporting 30 pieces of material B from the transportation destination 502 (transportation destination A) and notifies a vehicle 12 (vehicle B) of the instruction.

In this way, by causing the vehicle 12A to transport the product from the manufacturer 501 to the transportation destination 502 and instructing the same vehicle 12A to transport the article related to the product from the transportation destination 502 to the manufacturer 501, it is possible to improve the efficiency of transportation by the vehicle 12 compared with the case where such an instruction is not made. Further, by instructing the vehicle 12A to transport the article related to the product from the transportation destination 502 to the manufacturer 501, it is possible to transport the article by the vehicle 12A when necessary and only as necessary.

On the return route to the manufacturer after transportation of the product, it is conceivable that there is no article that should be transported from the transportation destination to the manufacturer. When there is no such article, the center server 30 may make an instruction that the transportation of the article is unnecessary to the vehicle 12 that has transported the product. That is, the center server 30 may instruct the vehicle 12 that has transported the product to return from the transportation destination to the manufacturer without loading anything. The center server 30 instructs the vehicle 12 that has transported the part to return from the transportation destination to the manufacturer without loading anything when there is no article that should be transported after the transportation of the product, so that the vehicle 12 can immediately return to the manufacturer, which can improve the efficiency of transportation by the vehicle 12.

Further, when there is no article that should be transported from the transportation destination to the manufacturer on the return route to the manufacturer after the transportation of the product, the center server 30 may instruct the vehicle 12 to transport the product to the delivery destination of the product without making a stop at the transportation destination. The vehicle 12 additionally transports the product from the transportation destination to the delivery destination, so that the efficiency of transportation can be further improved.

In the above embodiment, the transportation destination is located between the supplier of the article and the manufacturer of the product, and is a facility that temporarily stores the article and a facility temporarily stores the product. However, the present disclosure is not limited to such an example. The transportation destination may be the manufacturer of the article.

It should be noted that various processors other than the CPU may execute the transportation management process that is executed by the CPU reading the software (program) in each of the above embodiments. Examples of the processors in this case include a programmable logic device (PLD) such as a field-programmable gate array (FPGA) for which a circuit configuration can be changed after production, a dedicated electric circuit that is a processor having a circuit configuration designed exclusively for executing a specific process, such as an application specific integrated circuit (ASIC), and the like. In addition, the transportation management process may be executed by one of these various processors, or a combination of two or more processors of the same type or different types (for example, a combination of FPGAs and a combination of a CPU and an FPGA, and the like). Further, the hardware structure of these various processors is, more specifically, an electric circuit in which circuit elements such as semiconductor elements are combined.

Further, in each of the above embodiments, the mode in which the program of the transportation management process is stored (installed) in the ROM or the storage in advance has been described, but the present disclosure is not limited to this. The program may be recorded on a non-transitory recording medium such as a compact disc read-only memory (CD-ROM), a digital versatile disc read-only memory (DVD-ROM), and a universal serial bus (USB) memory to be provided. Further, the program may be downloaded from an external device via a network.

What is claimed is:

1. A transportation management device, comprising a processor, wherein the processor instructs a vehicle to transport a product from a manufacturer of the product to a transportation destination, and instructs, after the vehicle has transported the product, the vehicle to transport an article related to the product from the transportation destination to the manufacturer, based on a demand for the article.

2. The transportation management device according to claim 1, wherein the article is a material used for manufacturing the product.

3. The transportation management device according to claim 2, wherein the transportation destination is located between a supplier of the material and the manufacturer, and is a facility that temporarily stores the material and a facility that temporarily stores the product.

4. The transportation management device according to claim 1, wherein the processor manages inventory of the article at the manufacturer based on demand information of the product.

5. The transportation management device according to claim 4, wherein the processor manages the inventory of the article based on the demand information obtained based on malfunction information of another vehicle.

6. The transportation management device according to claim 4, wherein the processor manages the inventory of the article based on the demand information obtained based on weather information.

7. The transportation management device according to claim 1, wherein the processor manages inventory of the article related to the product at the manufacturer based on demand forecast for the product.

8. The transportation management device according to claim 1, wherein when there is no article to transport, the processor makes an instruction that transportation of the article is unnecessary to the vehicle.

9. A transportation management system, comprising:
the transportation management device according to claim 1; and
one or more vehicles that receive an instruction from the transportation management device.

10. A transportation management method that is performed through execution of processes by a processor, the processes comprising:
instructing a vehicle to transport a product from a manufacturer of the product to a transportation destination; and
instructing, after the vehicle has transported the product, the vehicle to transport an article related to the product from the transportation destination to the manufacturer, based on a demand for the article.

11. A non-transitory recording medium storing a transportation management program that causes a computer to execute processes comprising:
instructing a vehicle to transport a product from a manufacturer of the product to a transportation destination; and
instructing, after the vehicle has transported the product, the vehicle to transport an article related to the product from the transportation destination to the manufacturer, based on a demand for the article.
